(19) United States
(12) Patent Application Publication
(10) Pub. No.: US 2021/0027952 A1
(43) Pub. Date: Jan. 28, 2021

(54) METHOD FOR MANUFACTURING SOLID ELECTROLYTE ALUMINUM ELECTROLYTIC CAPACITOR

(71) Applicant: CAPXON ELECTRONIC(SHEN ZHEN) CO., LTD., Shenzhen (CN)

(72) Inventor: Yizhu LIN, Shenzhen (CN)

(21) Appl. No.: 16/695,095

(22) Filed: Nov. 25, 2019

(30) Foreign Application Priority Data
Jul. 22, 2019 (CN) 201910663123.6

(51) Int. Cl. H01G 9/00; H01G 9/028

(52) U.S. Cl. CPC H01G 9/0036; H01G 9/045; H01G 9/028

(57) ABSTRACT

This invention relates to capacitor manufacturing, and particularly to a method for manufacturing a solid aluminum electrolytic capacitor, including: cutting an anode aluminum foil to a desired width; welding the cut anode aluminum foil to a stainless steel strip, and coating an insulating adhesive to partition an anode zone from a cathode zone; forming the cut anode aluminum foil; preparing a first conductive polymer layer on the anode aluminum foil by chemical polymerization; preparing a second conductive polymer layer by impregnation; preparing a third conductive polymer layer by impregnation; preparing a fourth conductive polymer layer by electrochemical polymerization; preparing a carbon paste layer and a silver paste layer on the anode aluminum foil; and subjecting the resulting product to stacking, packaging, aging and sorting.

### CROSS-REFERENCE TO RELATED APPLICATIONS

This application claims the benefit of priority from Chinese Patent Application No. 201910663123.6, filed on Jul. 22, 2019. The content of the aforementioned application, including any intervening amendments thereto, is incorporated herein by reference in its entirety.

### TECHNICAL FIELD

This application relates to the manufacture of capacitors, and more particularly to a method for manufacturing a solid aluminum electrolytic capacitor.

### BACKGROUND OF THE INVENTION

Solid aluminum electrolytic capacitor is a commonly-used electronic component in which a conductive polymer instead of a liquid electrolyte is applied. Compared to the liquid aluminum electrolytic capacitor, the solid aluminum electrolytic capacitor has a smaller ESR, a more stable frequency characteristic and a higher safety.

Chinese Patent Application Publication CN 103632846 A discloses a solid electrolytic capacitor, in which a valve metal substrate forming a dielectric oxide film on the surface of the anode is alternately impregnated in a monomer solution and an oxidizing agent solution to form a first conductive polymer layer on the surface of the dielectric oxide film. The impregnating time in the oxidizing agent solution is no more than 15 s. Then, the capacitor with the first conductive polymer layer is impregnated in a soluble conductive polymer solution or a conductive polymer dispersion to form a second conductive polymer layer with a film thickness of small deviation. Finally, a cathode layer is formed on the conductive polymer layer.

Chinese Patent Application Publication CN 103562260 A discloses a solid electrolytic capacitor which includes a highly-conductive polymer, an aqueous conductive polymer solution and a conductive polymer film. Besides, this publication also provides a solid electrolytic capacitor with a reduced ESR and a manufacturing method thereof. In the method, a dielectric layer is formed on the surface of the anode conductor containing a valve metal. Then, a first conductive polymer layer is formed on the surface of the dielectric layer by oxidatively or electrically polymerizing the corresponding monomer. The surface of the first conductive polymer layer is impregnated in the aqueous conductive polymer solution to form a second conductive polymer layer. Therefore, this method can ensure the uniformity of the conductive polymer layer of the capacitor.

In the above two publications, the soluble conductive polymer solution or the conductive polymer dispersion has a single composition. Compared to the small particles, it is more difficult for the large particles to enter the surface pores, resulting in an insufficient withdrawing of capacitance. In addition, insufficient impregnation will also lead to insufficient withdrawing of capacitance while excessive impregnation will result in a higher ESR and a great increase in cost. After the capacitor component is impregnated in the soluble conductive polymer solution or the conductive polymer dispersion and dried to form a film, a dense chemically-bonded film layer is not formed at the outermost conductive polymer layer, so that the film layer at the corner of the prepared capacitor is thin, at which the leakage current generally occurs, leading to a low yield rate.

### SUMMARY OF THE INVENTION

An object of this application is to provide a method for manufacturing a solid aluminum electrolytic capacitor, in which the film thickness of the conductive polymer layers has a small deviation, and the capacitor has desirable withdrawing of capacitance and good ESR and tracking resistance.

The technical solutions of this application are described as follows. This application provides a method for manufacturing a solid aluminum electrolytic capacitor, comprising:

cutting an anode aluminum foil to a desired width;

welding the cut anode aluminum foil to a stainless steel strip, and coating an insulating adhesive to partition an anode zone from a cathode zone;

forming the cut anode aluminum foil;

preparing a first conductive polymer layer on the formed anode aluminum foil by chemical polymerization;

preparing a second conductive polymer layer by impregnation;

preparing a third conductive polymer layer by impregnation;

preparing a forth conductive polymer layer by electrochemical polymerization;

preparing a carbon paste layer and a silver paste layer on the anode aluminum foil; and

subjecting the resulting product to stacking, packaging, aging and sorting.

In some embodiments, the first conductive polymer layer includes polypyrrole, polythiophene, polyaniline, derivatives and copolymers thereof.

In some embodiments, the chemical polymerization includes:

impregnating the anode aluminum foil in a reducing solution for 0.3-3 min and drying the anode aluminum foil;

impregnating the anode aluminum foil in an oxidizing solution for 0.3-3 min and drying the anode aluminum foil; and

repeating the above steps for 1-5 times.

In some embodiments, the reducing solution consists of a monomer, a dopant and a solvent; the monomer is one compound selected from pyrrole, thiophene, aniline and derivatives thereof the dopant is one compound selected from compounds having a sulfonic acid group and compounds having a carboxyl group; and a concentration of the dopant is 0.01-1 mol/L.

In some embodiments, the solvent of the reduction solution is water, an organic solvent or a mixture of water and the organic solvent. The organic solvent is one of methanol, ethanol, propanol and butanol.

In some embodiments, the oxidizing solution comprises an oxidizing agent; the oxidizing agent is one of ferric p-toluenesulfonate, ammonium persulfate, potassium permanganate, perchloric acid and hydrogen peroxide, and has a mass concentration of 0.5%-20%; a solvent of the oxidizing solution is water, an organic solvent or a mixture thereof; and the organic solvent is one of methanol, ethanol, propanol and butanol.

In some embodiments, the step of preparing the second conductive polymer layer by impregnation comprises:

impregnating the anode aluminum foil in a dispersion and drying the anode aluminum foil; and repeating the above steps 2-15 times;

where a solute of the dispersion is polypyrrole, polythiophene, polyaniline, a derivative or a copolymer thereof; and

suspended polymer particles in the dispersion have a particle size of less than 100 nm.

In some embodiments, the step of preparing the third conductive polymer layer by impregnation comprises:

impregnating the anode aluminum foil in a dispersion and drying the anode aluminum foil; and repeating the above steps 1-3 times;

where a solute of the dispersion is polypyrrole, polythiophene, polyaniline or a derivative thereof; and

suspended polymer particles have a particle size of less than 500 nm.

In some embodiments, the step of preparing the forth conductive polymer layer by electrochemical polymerization comprises:

subjecting the anode aluminum foil to a constant current or voltage;

where the constant current for the electrochemical polymerization is 0.1-10 mA;

the constant voltage for the electrochemical polymerization is 0.01-2.5 V; a time of the electrochemical polymerization is 1-200 min; and a temperature of a polymerizing solution is 4-30° C.

In some embodiments, the polymerizing solution consists of a monomer, a dopant and a solvent;

where the monomer is pyrrole or thiophene, and has a mass percentage of 1-15%;

the dopant is a compound having a sulfonic acid group or a carboxyl group, or a derivative or a salt thereof, and has a concentration of 0.1-3 mol/L; and

the solvent is water, an organic solvent or a mixture thereof.

Compared with the prior art, this application employs four conductive polymer layers, where first conductive polymer layer is prepared by chemical polymerization; the second conductive polymer layer is prepared by impregnation in a dispersion of small-size particles; the third conductive polymer layer is prepared by impregnation in a dispersion of particles larger than those for the preparation of the second conductive layer; and the dense forth conductive polymer layer is prepared by electrochemical polymerization. Based on the above, this application not only reduces the thickness of the capacitor bottom, but also improves the withdrawing of capacitance, ESR and the leakage current.

### BRIEF DESCRIPTION OF THE DRAWINGS

The technical solutions in the prior art or in embodiments of the invention will be more clearly described below with reference to the drawings. Obviously, described below are merely some embodiments of the invention, and various variations and modifications of the invention can be made by those skilled in the art without departing from the spirit and scope of the invention.

FIG. 1 is a cross-sectional view of an anode aluminum foil of a solid aluminum electrolytic capacitor according to an embodiment of the invention.

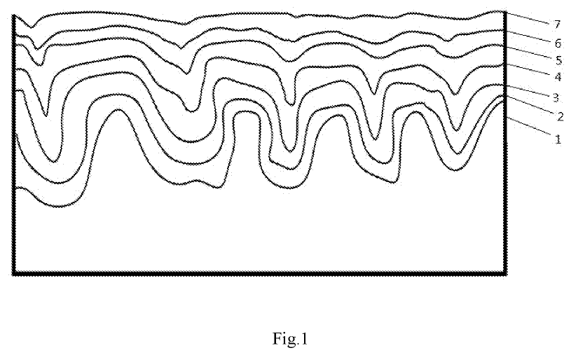

### DETAILED DESCRIPTION OF EMBODIMENTS

In order to make the objects, technical solutions and advantages of the invention clearer, the invention will be further described below with reference to the drawings. It should be understood that these embodiments are merely illustrative of the invention, and are not intended to limit the invention.

In addition, the technical features involved in different embodiments may be combined as long as they are not mutually contradictory.

### Example 1

This embodiment provided a method for manufacturing a solid aluminum electrolytic capacitor (referring to the FIGURE), which was specifically described as follows.

S100)

An anode aluminum foil 1 was cut to a desired width.

S200)

The cut anode aluminum foil 1 was welded to a stainless steel strip, and then an insulating adhesive was coated to partition an anode zone from a cathode zone.

S300)

The cut anode aluminum foil 1 was formed.

S400)

A first conductive polymer layer 2 was prepared on the anode aluminum foil 1 by chemical polymerization.

S500)

A second conductive polymer layer 3 was prepared by impregnation.

S600)

A third conductive polymer layer 4 was prepared by impregnation.

S700)

A forth conductive polymer layer 5 was prepared by electrochemical polymerization.

S800)

A carbon paste layer 6 and a silver paste layer 7 were prepared on the anode aluminum foil 1.

S900)

The resulting product was subjected to stacking, packaging, aging and sorting. In step (S400), the chemical polymerization was performed as follows. The anode aluminum foil 1 was impregnated in a reducing solution for 1 min, dried at 50° C. for 20 min and then impregnated in an oxidizing solution for 1 min. Such process was repeated twice.

The reducing solution consisted of a monomer, a dopant and a solvent, where the monomer was 5% by weight of thiophene; the dopant was 1 mol/L p-toluenesulfonic acid; and the solvent was a mixture of water and ethanol.

The oxidizing solution was 3% by weight of ammonium persulfate, in which a solvent was water.

In step (S500), the preparation of the second conductive polymer layer 3 by impregnation was performed as follows. The anode aluminum foil was impregnated in a dispersion and then dried at 110° C. for 10 min, where a solute in the dispersion was 5% by weight of polythiophene having a particle size of less than 50 nm. Such process was repeated 4 times.

In step (S600), the preparation of the third conductive polymer layer 4 by impregnation was performed as follows. The anode aluminum foil was impregnated in a dispersion and then dried at 110° C. for 15 min, where a solute in the dispersion was 3% by weight of polythiophene having a particle size of less than 200 nm. Such process was repeated 4 times.

In step (S700), the preparation of the forth conductive polymer layer 5 by electrochemical polymerization was performed as follows. The anode aluminum foil was immersed in a polymerizing solution under a 3 mA constant current for 30 min, where a temperature of the polymerizing solution was 10° C. The polymerizing solution consisted of a monomer, a dopant and a solvent, where the monomer was 6% by weight of pyrrole; the dopant was 0.5 mol/L sodium p-toluenesulfonate; and the solvent was water.

### Example 2

This embodiment provided a method for manufacturing a solid aluminum electrolytic capacitor (referring to the FIGURE), which was specifically described as follows.

S100)

An anode aluminum foil 1 was cut to a desired width.

S200)

The cut anode aluminum foil 1 was welded to a stainless steel strip, and then an insulating adhesive was coated to partition an anode zone from a cathode zone.

S300)

The cut anode aluminum foil 1 was formed.

S400)

A first conductive polymer layer 2 was prepared on the anode aluminum foil 1 by chemical polymerization.

S500)

A second conductive polymer layer 3 was prepared by impregnation.

S600)

A third conductive polymer layer 4 was prepared by impregnation.

S700)

A forth conductive polymer layer 5 was prepared by electrochemical polymerization.

S800)

A carbon paste layer 6 and a silver paste layer 7 were prepared on the anode aluminum foil 1.

S900)

The resulting product was subjected to stacking, packaging, aging and sorting.

In step (S400), the chemical polymerization was performed as follows. The anode aluminum foil 1 was impregnated in a reducing solution for 2 min, dried at 100° C. for 10 min and then impregnated in an oxidizing solution for 1 min. Such process was repeated 5 times.

The reducing solution consisted of a monomer, a dopant and a solvent, where the monomer was 3% by weight of pyrrole; the dopant was 1.5 mol/L p-toluenesulfonic acid; and the solvent was a mixture of water and ethanol.

The oxidizing solution was 3% by weight of ferric p-toluenesulfonate, in which a solvent was water.

In step (S500), the preparation of the second conductive polymer layer 3 by impregnation was performed as follows. The anode aluminum foil was impregnated in a dispersion and then dried at 110° C. for 30 min, where a solute in the dispersion was 5% by weight of polyaniline having a particle size of less than 30 nm. Such process was repeated twice.

In step (S600), the preparation of the third conductive polymer layer 4 by impregnation was performed as follows. The anode aluminum foil was impregnated in a dispersion and then dried at 100° C. for 10 min, where a solute in the dispersion was 5% by weight of polyaniline having a particle size of less than 200 nm. Such process was repeated twice.

In step (S700), the preparation of the forth conductive polymer layer 5 by electrochemical polymerization was performed as follows. The anode aluminum foil was immersed in a polymerizing solution under a 1 mA constant current for 70 min, where a temperature of the polymerizing solution was 20° C. The polymerizing solution consisted of a monomer, a dopant and a solvent, where the monomer was 3% by weight of thiophene; the dopant was 1 mol/L sodium p-toluenesulfonate; and the solvent was water.

### Example 3

This embodiment provided a method for manufacturing a solid aluminum electrolytic capacitor (referring to the FIGURE), which was specifically described as follows.

S100)

An anode aluminum foil 1 was cut to a desired width.

S200)

The cut anode aluminum foil 1 was welded to a stainless steel strip, and then an insulating adhesive was coated to partition an anode zone from a cathode zone.

S300)

The cut anode aluminum foil 1 was formed.

S400)

A first conductive polymer layer 2 was prepared on the anode aluminum foil 1 by chemical polymerization.

S500)

A second conductive polymer layer 3 was prepared by impregnation.

S600)

A third conductive polymer layer 4 was prepared by impregnation.

S700)

A forth conductive polymer layer 5 was prepared by electrochemical polymerization.

S800)

A carbon paste layer 6 and a silver paste layer 7 were prepared on the anode aluminum foil 1.

S900)

The resulting product was subjected to stacking, packaging, aging and sorting.

In step (S400), the chemical polymerization was performed as follows. The anode aluminum foil 1 was impregnated in a reducing solution for 1 min, dried at 50° C. for 20 min and then impregnated in an oxidizing solution for 1 min. Such process was repeated twice.

The reducing solution consisted of a monomer, a dopant and a solvent, where the monomer was 1% by weight of thiophene; the dopant was 1 mol/L p-toluenesulfonic acid; and the solvent was a mixture of water and ethanol.

The oxidizing solution was 3% by weight of ammonium persulfate, in which a solvent was water.

In step (S500), the preparation of the second conductive polymer layer 3 by impregnation was performed as follows. The anode aluminum foil was impregnated in a dispersion and then dried at 110° C. for 10 min, where a solute in the dispersion was 5% by weight of polythiophene having a particle size of less than 50 nm. Such process was repeated 4 times.

In step (S600), the preparation of the third conductive polymer layer 4 by impregnation was performed as follows. The anode aluminum foil was impregnated in a dispersion and then dried at 140° C. for 15 min, where a solute in the dispersion was 3% by weight of polythiophene having a particle size of less than 200 nm. Such process was repeated 4 times.

In step (S700), the preparation of the forth conductive polymer layer 5 by electrochemical polymerization was performed as follows. The anode aluminum foil was immersed in a polymerizing solution under a 1 mA constant current for 70 min, where a temperature of the polymerizing solution was 20° C. The polymerizing solution consisted of a monomer, a dopant and a solvent, where the monomer was 3% by weight of thiophene; the dopant was 1 mol/L sodium p-toluenesulfonate; and the solvent was water.

### Example 4

This embodiment provided a method for manufacturing a solid aluminum electrolytic capacitor (referring to the FIGURE), which was specifically described as follows.

S100)

An anode aluminum foil 1 was cut to a desired width.

S200)

The cut anode aluminum foil 1 was welded to a stainless steel strip, and then an insulating adhesive was coated to partition an anode zone from a cathode zone.

S300)

The cut anode aluminum foil 1 was formed.

S400)

A first conductive polymer layer 2 was prepared on the anode aluminum foil 1 by chemical polymerization.

S500)

A second conductive polymer layer 3 was prepared by impregnation.

S600)

A third conductive polymer layer 4 was prepared by impregnation.

S700)

A forth conductive polymer layer 5 was prepared by electrochemical polymerization.

S800)

A carbon paste layer 6 and a silver paste layer 7 were prepared on the anode aluminum foil 1.

S900)

The resulting product was subjected to stacking, packaging, aging and sorting.

In step (S400), the first conductive polymer layer 2 comprises polypyrrole, polythiophene, polyaniline and derivatives and copolymers thereof; the chemical polymerization was performed as follows. The anode aluminum foil 1 was impregnated in a reducing solution for 0.3-3 min and dried, and then impregnated in an oxidizing solution for 0.3-3 min. Such process was repeated 1-5 times.

The reducing solution consisted of a monomer, a dopant and a solvent, where the monomer is one compound selected from pyrrole, thiophene, aniline and derivatives thereof; the dopant is one compound selected from compounds having a sulfonic acid group and compounds having a carboxyl group; and a concentration of the dopant is 0.01-1 mol/L. The solvent of the reducing solution is water, an organic solvent or a mixture thereof; and the organic solvent is one of methanol, ethanol, propanol and butanol.

The oxidizing solution comprises an oxidizing agent; the oxidizing agent is one of ferric p-toluenesulfonate, ammonium persulfate, potassium permanganate, perchloric acid and hydrogen peroxide, and has a mass concentration of 0.5%-20%; a solvent of the oxidizing solution is water, an organic solvent or a mixture thereof; and the organic solvent is one of methanol, ethanol, propanol and butanol.

In step (S500), the preparation of the second conductive polymer layer 3 by impregnation was performed as follows. The anode aluminum foil was impregnated in a dispersion and then dried, where a solute of the dispersion is polypyrrole, polythiophene, polyaniline, a derivative or a copolymer thereof; and suspended polymer particles in the dispersion have a particle size of less than 100 nm. Such process was repeated 2-15 times.

In step (S600), the preparation of the third conductive polymer layer 4 by impregnation was performed as follows. The anode aluminum foil was impregnated in a dispersion and then dried, where a solute of the dispersion is polypyrrole, polythiophene, polyaniline or a derivative thereof; and suspended polymer particles have a particle size of less than 500 nm. Such process was repeated 1-3 times.

In step (S700), the preparation of the forth conductive polymer layer 5 by electrochemical polymerization was performed as follows. The anode aluminum foil was immersed in a polymerizing solution under a 0.1-10 mA constant current or a 0.01-2.5 V constant voltage for 1-200 min, where a temperature of the polymerizing solution was 4-30° C. The polymerizing solution consists of a monomer, a dopant and a solvent; where the monomer is pyrrole or thiophene, and has a mass percentage of 1-15%; the dopant is a compound having a sulfonic acid group or a carboxyl group, or a derivative or a salt thereof, and has a concentration of 0.1-3 mol/L; and the solvent is water, an organic solvent or a mixture thereof.

In summary, the invention employs four conductive polymer layers on the anode aluminum foil 1, where first conductive polymer layer 2 is prepared by chemical polymerization; the second conductive polymer layer 3 is prepared by impregnation in a dispersion of small-size particles; the third conductive polymer layer 4 is prepared by impregnation in a dispersion of particles larger than those for the preparation of the second conductive layer 3; and the dense forth conductive polymer layer 5 is prepared by electrochemical polymerization. Based on the above, the invention not only reduces the thickness of the capacitor bottom, but also improves the withdrawing of capacitance, ESR and the leakage current, providing a better cost-effective capacitor with a stronger market competitiveness.

Obviously, the above-mentioned embodiments are merely illustrative of the invention, and are not intended to limit the invention. Various variations and modifications made by those skilled in the art without paying any creative effort should fall within the scope of the invention.

1. A method for manufacturing a solid aluminum electrolytic capacitor, comprising:
cutting an anode aluminum foil to a desired width;
welding the cut anode aluminum foil to a stainless steel strip, and coating an insulating adhesive to partition an anode zone from a cathode zone;
forming the cut anode aluminum foil;
preparing a first conductive polymer layer on the formed anode aluminum foil by chemical polymerization;
preparing a second conductive polymer layer by impregnation;
preparing a third conductive polymer layer by impregnation;
preparing a fourth conductive polymer layer by electrochemical polymerization;
preparing a carbon paste layer and a silver paste layer on the anode aluminum foil; and
subjecting the resulting product to stacking, packaging, aging and sorting;
the step of preparing the third conductive polymer layer by impregnation comprises:
impregnating the anode aluminum foil in a dispersion and drying the anode aluminum foil; and repeating the above steps 1-3 times;
wherein a solute of the dispersion is polypyrrole, polythiophene, polyaniline or a derivative thereof; and
suspended polymer particles in the dispersion have a particle size of less than 500 nm.

2. The method of claim 1, wherein the first conductive polymer layer comprises polypyrrole, polythiophene, polyaniline and derivatives and copolymers thereof.

3. The method of claim 1, wherein the chemical polymerization comprises:
impregnating the anode aluminum foil in a reducing solution for 0.3-3 min and drying the anode aluminum foil;
impregnating the anode aluminum foil in an oxidizing solution for 0.3-3 min and drying the anode aluminum foil; and
repeating the above steps 1-5 times.

4. The method of claim 3, wherein the reducing solution consists of a monomer, a dopant and a solvent; the monomer is one compound selected from pyrrole, thiophene, aniline and derivatives thereof; the dopant is one compound selected from compounds having a sulfonic acid group and compounds having a carboxyl group; and a concentration of the dopant is 0.01-1 mol/L.

5. The method of claim 4, wherein the solvent of the reducing solution is water, an organic solvent or a mixture thereof; and the organic solvent is one of methanol, ethanol, propanol and butanol.

6. The method of claim 3, wherein the oxidizing solution comprises an oxidizing agent; the oxidizing agent is one of ferric p-toluenesulfonate, ammonium persulfate, potassium permanganate, perchloric acid and hydrogen peroxide, and has a mass concentration of 0.5%-20%; a solvent of the oxidizing solution is water, an organic solvent or a mixture thereof; and the organic solvent is one of methanol, ethanol, propanol and butanol.

7. The method of claim 1, wherein the step of preparing the second conductive polymer layer by impregnation comprises:
impregnating the anode aluminum foil in a dispersion and drying the anode aluminum foil; and repeating the above steps 2-15 times;
wherein a solute of the dispersion is polypyrrole, polythiophene, polyaniline, a derivative or a copolymer thereof; and
suspended polymer particles in the dispersion have a particle size of less than 100 nm.

8. (canceled)

9. The method of claim 1, wherein the step of preparing the fourth conductive polymer layer by electrochemical polymerization comprises:
subjecting the anode aluminum foil to a constant current or voltage;
wherein the constant current for the electrochemical polymerization is 0.1-10 mA; the constant voltage for the electrochemical polymerization is 0.01-2.5 V; a time of the electrochemical polymerization is 1-200 min; and a temperature of a polymerizing solution is 4-30° C.

10. The method of claim 9, wherein the polymerizing solution consists of a monomer, a dopant and a solvent;
wherein the monomer is pyrrole or thiophene, and has a mass percentage of 1-15%;
the dopant is a compound having a sulfonic acid group or a carboxyl group, or a derivative or a salt thereof, and has a concentration of 0.1-3 mol/L; and
the solvent is water, an organic solvent or a mixture thereof.
